(19) United States
(12) Patent Application Publication
(10) Pub. No.: US 2024/0057213 A1
(43) Pub. Date: Feb. 15, 2024

(54) METHOD AND APPARATUS FOR ENHANCED CONNECTED MODE DISCONTINUOUS RECEPTION CONSIDERING TRAFFIC PERIOD IN WIRELESS COMMUNICATION SYSTEM

(71) Applicant: Samsung Electronics Co., Ltd., Suwon-si (KR)

(72) Inventors: Jeongseok YU, Suwon-si (KR); Hyunjeong KANG, Suwon-si (KR); Taeseop LEE, Suwon-si (KR)

(21) Appl. No.: 18/366,152

(22) Filed: Aug. 7, 2023

(30) Foreign Application Priority Data
Aug. 9, 2022 (KR) 10-2022-0099010

(51) Int. Cl. H04W 76/28; H04W 8/24

(52) U.S. Cl. CPC H04W 76/28; H04W 8/24

(57) ABSTRACT

The disclosure relates to a 5G or 6G communication system for supporting a higher data transmission rate. The disclosure relates to a method performed by a terminal in a wireless communication system, the method comprises transmitting, to a base station, a first message including first information indicating whether a connected mode-discontinuous reception (C-DRX) cycle of a non-integer format is supported, receiving, from the base station, a second message including C-DRX configuration including information on the C-DRX cycle based on the first information and configuring the C-DRX cycle based on the information on the C-DRX cycle.

### CROSS-REFERENCE TO RELATED APPLICATIONS

This application is based on and claims priority under 35 U.S.C. § 119 to Korean Patent Application No. 10-2022-0099010, filed on Aug. 9, 2022, in the Korean Intellectual Property Office, the disclosure of which is herein incorporated by reference in its entirety.

### BACKGROUND

### 1. Field

The disclosure relates to operations of a terminal and a base station in a wireless communication system. Further, the disclosure relates to a method and an apparatus for reducing power consumption of a terminal using an application transmitting or receiving various periods of traffic including extended reality (XR) through enhanced connected mode discontinuous reception (C-DRX) considering traffic transmission periods in a wireless communication system.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The disclosure is to provide a method and apparatus for reducing power consumption due to active time mismatched with a traffic period through an enhanced C-DRX considering a traffic period in a wireless communication system, so as to effectively provide a service having various periods of traffic including XR.

According to an aspect of the disclosure, a method performed by a terminal in a wireless communication system is provided. The method comprises transmitting, to a base station, a first message including first information indicating whether a connected mode-discontinuous reception (C-DRX) cycle of a non-integer format is supported, receiving, from the base station, a second message including C-DRX configuration including information on the C-DRX cycle based on the first information, and configuring the C-DRX cycle based on the information on the C-DRX cycle.

According to an aspect of the disclosure, a method performed by a base station in a wireless communication system is provided. The method comprises receiving, from a terminal, a first message including first information indicating whether a connected mode-discontinuous reception (C-DRX) cycle of a non-integer format is supported, transmitting, to the terminal, a second message including C-DRX configuration including information on the C-DRX cycle based on the first information and configuring the C-DRX cycle for the terminal based on the information on the C-DRX cycle.

According to an aspect of the disclosure, a terminal in a wireless communication system is provided. The terminal comprises a transceiver and a controller configured to transmit, to a base station via the transceiver, a first message including first information indicating whether a connected mode-discontinuous reception (C-DRX) cycle of a non-integer format is supported, to receive, from the base station via the transceiver, a second message including C-DRX configuration including information on the C-DRX cycle based on the first information, and to configure the C-DRX cycle based on the information on the C-DRX cycle.

According to an aspect of the disclosure, a base station in a wireless communication system is provided. The base station comprises a transceiver and a controller configured to receive, from a terminal via the transceiver, a first message including first information indicating whether a connected mode-discontinuous reception (C-DRX) cycle of a non-integer format is supported, to transmit, to the terminal via the transceiver, a second message including C-DRX configuration including information on the C-DRX cycle based on the first information, and to configure the C-DRX cycle for the terminal based on the information on the C-DRX cycle.

In order to solve the above problem, the disclosure provides a method for processing a control signal in a wireless communication system, the method including receiving a first control signal transmitted from a base station, processing the received first control signal, and transmitting a second control signal generated based on the processing to the base station.

The technical subjects pursued in the disclosure may not be limited to the above-mentioned technical subjects, and other technical subjects which are not mentioned may be clearly understood, through the following descriptions, by those skilled in the art to which the disclosure pertains.

According to an aspect of the disclosure, a method and an apparatus for establishing and using a connected mode discontinuous reception (C-DRX) considering a traffic transmission period in a wireless communication system can be provided.

Advantageous effects obtainable from the disclosure may not be limited to the above-mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a C-DRX technique for reducing power consumption of a terminal in a connected mode in a wireless communication system according to an embodiment of the present disclosure;

FIG. 2 illustrates a method for supporting fine-grained C-DRX cycles in a wireless communication system according to an embodiment of the present disclosure;

FIG. 3 illustrates a method for supporting non-integer C-DRX cycles in a wireless communication system according to an embodiment of the present disclosure;

FIG. 4 illustrates a method for supporting patterned C-DRX cycles according to an embodiment of the present disclosure;

FIG. 5 illustrates a method for supporting extended SFN wraparound according to an embodiment of the present disclosure;

FIG. 6 illustrates a method for providing enhanced drx preference through UAI to a base station according to an embodiment of the present disclosure;

FIG. 7 illustrates a method for providing traffic patterns of a terminal to a base station through UAI according to an embodiment of the present disclosure;

FIG. 8 illustrates a structure of a base station according to an embodiment of the present disclosure; and

FIG. 9 illustrates a structure of a terminal according to an embodiment of the present disclosure.

### DETAILED DESCRIPTION

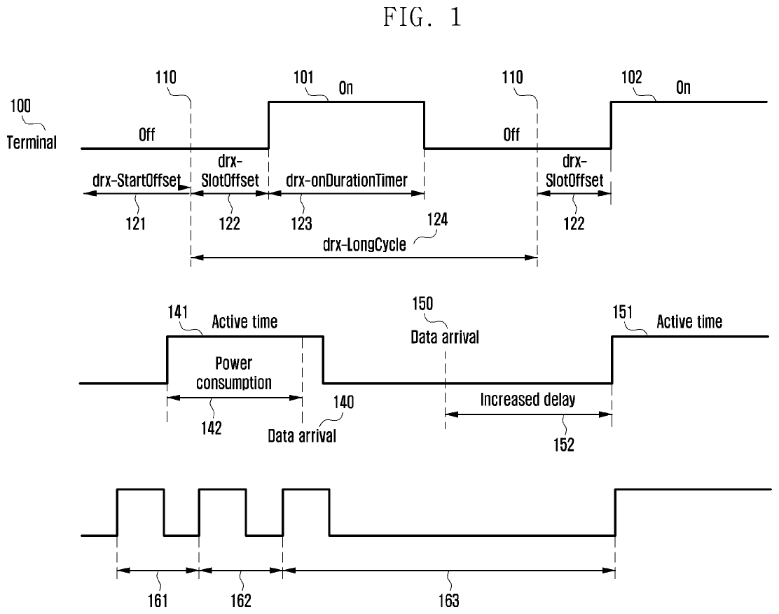

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Furthermore, the “unit” in the embodiments may include one or more processors.

The description of embodiments of the disclosure is mainly directed to New Radio (NR) as a radio access network and Packet Core 5G system or 5G Core Network or Next Generation Core (NG Core) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station.

The disclosure relates to a method and an apparatus for enhanced connected mode discontinuous reception (C-DRX) considering traffic transmission periods in a wireless communication system. Specifically, the disclosure may provide a method and an apparatus for reducing power consumption due to active time mismatched with traffic periods through enhanced C-DRX that considers a short period, various periods, or a non-integer period, which may be a characteristic of service traffic including extended reality (XR) traffic in a wireless communication system, thereby describing a technique for effectively providing services having various periods of traffic including XR.

FIG. 1 illustrates a C-DRX technique for reducing power consumption of a terminal in a connected mode in a wireless communication system according to an embodiment of the present disclosure.

A base station may indicate resource allocation information on a physical downlink control channel (PDCCH) and perform data transmission on a physical downlink shared channel (PDSCH) in order to transmit downlink data to the terminal in a connected terminal, and may indicate resource allocation information on the PDCCH and transmit data on a physical uplink shared channel (PUSCH) in order to receive uplink data of the terminal. The base station may be configured to intermittently monitor the PDCCH based on traffic patterns, service requirements, and the like to reduce power consumption of a terminal 100 (indicated by reference numerals 101 and 102), and this power consumption reduction technique may be defined using DRX, and more particularly, DRX operating in a connected mode may be defined as C-DRX. The terminal monitors the PDCCH of serving cells belonging to a DRX group when at least one of the following conditions is satisfied, which may be defined as the active time of the DRX group.

Condition 1: The drx-onDurationTimer or drx-InactivityTimer configured in a DRX group is running.

Condition 2: drx-RetransmissionTimerDL or drx-RetransmissionTimerUL is running in a serving cell belonging to a DRX group.

Condition 3: ra-ContentionResolutionTimer or msgB-ResponseWindow is running.

Condition 4: A scheduling request transmitted to a physical uplink control channel (PUCCH) is in a pending state.

Condition 5: After successful reception of a random access response (RAR) to a random access preamble not selected by medium access control (MAC) of the terminal, a PDCCH for the allocation of resources indicated by a cell radio network temporary identifier (C-RNTI) of the MAC has not yet been received.

The base station may configure DRX on the terminal 100, including drx-onDurationTimer 123, drx-SlotOffset 122, drx-InactivityTimer, drx-RetransmissionTimerDL, drx-RetransmissionTimerUL, drx-LongCycleStartOffset, drx-HARQ-RTT-TimerDL, drx-HARQ-RTT-TimerUL. Drx-LongCycleStartOffset may be configured in the form of {ms10, INTEGER(0 . . . 9)}, as an example, referring to 3GPP TS 38.331, where ms10 refers to drx-LongCycle 124 of 10 milliseconds (ms) and a value expressed as INTEGER refers to drx-StartOffset 121. As such, the terminal 100 determines the drx-LongCycle 124 and the drx-StartOffset 122 from the drx-LongCycleStartOffset and, referring to 3GPP TS 38.321, may start the drx-onDurationTimer 123 after the drx-SlotOffset 122 from the start of subframe when the following conditions are satisfied (indicated by reference numeral 110).

Condition: Long DRX cycle is used for a DRX group, where [(SFN×10)+subframe number] modulo (drx-LongCycle)=drx-StartOffset.

XR traffic may include many different types of traffic. Traffic to provide XR services such as VR, CG, and AR, which are typical services, may include one or more of the video, audio, data, field of view (FOV), omnidirectional view, and pose/control, according to technical report (TR) 38.838 progressed in 3GPP radio access network (RAN) working group 1 (WG 1). Such traffic may have a generation period according to an application or type. For example, video traffic may have a period of 24, 30, 60, 90 Hz, etc., audio traffic may have a period of 10 ms, and pose/control may have a period of 4 ms.

The difference between the traffic generation period and C-DRX cycle of the terminal may vary the difference between a time point at which traffic occurs and a time point at which active time begins. In an example, starting the active time too early (indicated by reference numeral 141) relative to the traffic generation time point 140 may increase PDCCH monitoring power consumption (indicated by reference numeral 142), or starting the active time too late (indicated by reference numeral 151) relative to the traffic generation time point 150 may increase latency (indicated by reference numeral 152). In an example, when the C-DRX cycle is configured to be short (indicated by reference numeral 161, 162) to reduce latency in services including XR, which may have low latency requirements compared to typical traffic, power consumption may increase due to an increase in the active time ratio or frequent on/off change of a receiver compared to a longer C-DRX cycle, whereas configuring the C-DRX cycle to be longer to reduce power consumption (indicated by reference numeral 163) may increase latency compared to a case of the shorter C-DRX cycle. Therefore, it may be helpful to configure and use a more fine-grained C-DRX cycle than drx-LongCycle, such as 10 ms, 20 ms, 32 ms, 40 ms, which are values that can be configured in 3GPP release 17.

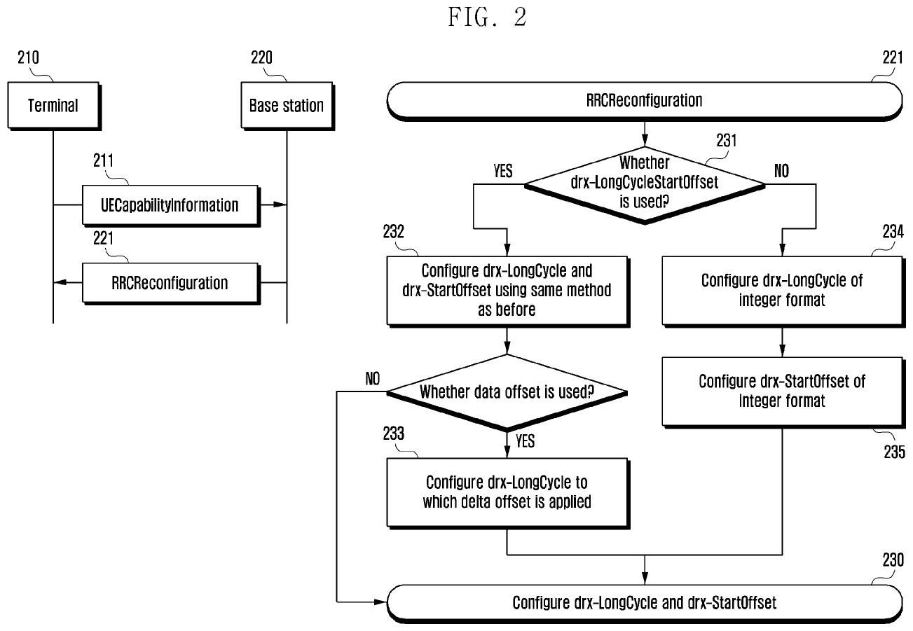

FIG. 2 illustrates a method for supporting fine-grained C-DRX cycles in a wireless communication system according to an embodiment of the present disclosure.

A fine-grained C-DRX cycle may provide flexibility in configuration, and may select a value that corresponds to different traffic periods and appropriately considers power consumption and latency. A terminal 210 may report, to the base station 220, a first message including information indicating whether a fine-grained C-DRX cycle is supported. The first message may be RRC UECapabilityInformation 211. The terminal 210 may report, to the base station 220, at least one of the following pieces of information individually or in combination.

Information 1: Whether fine-grained C-DRX cycle is supported;

Information 2: Whether C-DRX cycle in the unit of millisecond (ms) is supported;

Information 3: Whether C-DRX cycle in the unit of slot is supported; or

Information 4: Whether C-DRX cycle in the unit of microsecond (us) is supported.

The base station 220 may transmit a second message including a C-DRX configuration to the terminal 210 with reference to whether the terminal 210 supports a fine-grained C-DRX cycle. The second message may be an RRCReconfiguration message 221. The base station 220 may implicitly or explicitly use at least one of the following pieces of information to configure a fine-grained C-DRX cycle 230:
Information 1: C-DRX in the unit of ms or slot;
Information 2: Additional values with the same structure as that of drx-LongCycleStartOffset of the existing 3GPP release 17 (as an embodiment, {m58, INTEGER(0 . . . 7)}, {ms16, INTEGER(0 . . . 15)}, . . . );
Information 3: Delta offset to be applied to drx-LongCycle. The unit of ms, slot, or us may be explicitly indicated. A positive or negative delta value may be explicitly indicated;
Information 4: drx-LongCycle in the integer format. The unit of ms, slot, or us may be explicitly indicated. The ms and us units may be configured separately;
Information 5: drx-StartOffset in the integer format; or
Information 6: Subcarrier spacing (SCS) used for slot unit calculation. The slot length, SCS, or numerology may be configured in the form of enum (enumerate). When information 6 is not included, the lowest SCS of the active BWPs in the DRX group may be used as the SCS used for slot unit calculation.

The terminal 210 receives the RRCReconfiguration message 221. The terminal 220 may identify whether drx-LongCycleStartOffset is used, based on the RRCReconfiguration message (operation 231). The procedure proceeds to operation 232 when drx-LongCycleStartOffset is used, and the procedure proceeds to operation 234 when drx-LongCycleStartOffset is not used.

If drx-LongCycleStartOffset is used, the terminal 210 may configure drx-LongCycle and drx-StartOffset in the same method as before (operation 232).

The terminal 210 may identify whether delta offset is used.

In case that the delta offset is used, the terminal 210 may convert drx-LongCycle into a value of an the implicitly or explicitly transferred unit (ms, slot, us), and then may configure, drx-LongCycle (as new drx-LongCycle), a value obtained by subtracting (minus) or adding (plus) the delta offset from or to the converted drx-LongCycle (operation 233). When the drx-LongCycle is converted into the drx-LongCycle in the unit of slot, the drx-LongCycle may be expressed as a value obtained by multiplying two to the power of numerology. For example, a drx-LongCycle of 20 ms may be expressed by an SCS of 30 kHz, that is, 40 slots when the numerology is 1. When drx-LongCycle is converted into drx-LongCycle in the us unit, the drx-LongCycle may be expressed as a value obtained by multiplying 1000.

The terminal 210 may configure the drx-LongCycle and drx-StartOffset in the integer format when the drx-LongCycleStartOffset is not used (operation 234 and 235).

Additionally, the terminal 210 may configure a fine-grained drx-ShortCycle by using the same structure as that of Information 3, or the same configuration as that of Information 4.

The terminal 210 using a fine-grained C-DRX cycle may start the drx-onDurationTimer after drx-SlotOffset from the start of the subframe or slot through the C-DRX configuration in the implicit or explicit unit of ms or slot, provided that the following conditions are satisfied.

When using C-DRX in the unit of ms: Long DRX cycle is used for a DRX group, and [(SFN×10)+subframe number] modulo (drx-LongCycle)=drx-StartOffset.

When using C-DRX in the unit of slot: Long DRX cycle is used for a DRX group, and [numberOfSlotsPerFrame×SFN+slot number in the frame] modulo (drx-LongCycle)=drx-StartOffset. Here, drx-StartOffset is converted into drx-StartOffset in the unit of slot.

In case that drx-LongCycle is drx-LongCycle in the unit of us, and in case that C-DRX in the unit of ms is used: Long DRX cycle is used for a DRX group, and drx-StartOffset≤{{[(SFN×10)+subframe number]×1000} modulo (drx-LongCycle)}<drx-StartOffset+1000.

In case that drx-LongCycle is drx-LongCycle in the unit of us, and in case that C-DRX in the unit of slot is used: Long DRX cycle is used for a DRX group and drx-StartOffset≤{{[numberOfSlotsPerFrame×SFN+slot number in the frame]×lengthOfSlot} modulo (drx-LongCycle)}≤drx-StartOffset+lengthOfSlot. Here, drx-StartOffset is converted into drx-StartOffset in the unit of us, and lengthOfSlot has a value of indicating the length of one slot in the unit of us.

The above formula may be modified to facilitate calculations using well-known functions such as floor, ceil, round, floor modulo, etc. In addition, the terminal may use a fine-grained short cycle through the same level of change as drx-LongCycle when the fine-grained drx-ShortCycle is configured.

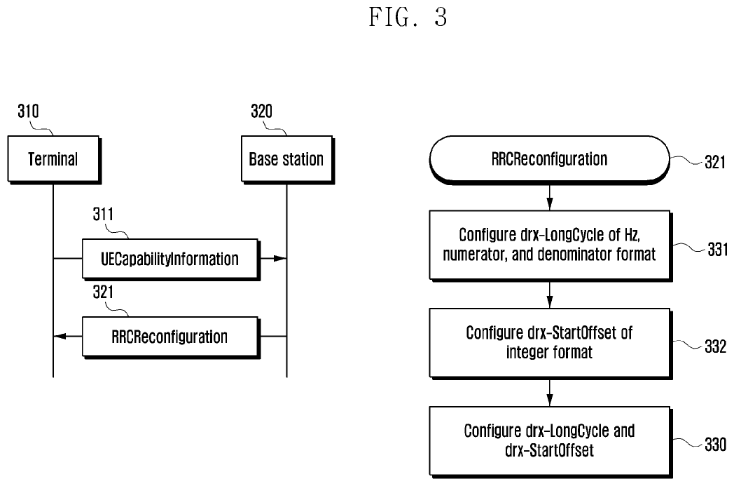

FIG. 3 illustrates a method for supporting non-integer C-DRX cycles in a wireless communication system according to an embodiment of the present disclosure.

A non-integer period refers to, as an example, a period that is not divisible by 15, 30, 60 Hz, etc., and when expressing as a fraction, 15 Hz may be expressed as a cycle that occurs every 3/200 seconds, 30 Hz may be expressed as a cycle that occurs every 3/100 seconds, and 60 Hz may be expressed as a cycle that occurs every 3/50 seconds. These non-integer periods may be used when it is required to configure new units other than the existing C-DRX units, or the ms, slot, and us units described in FIG. 2.

A terminal 310 may report, to a base station 320, a first message including information indicating whether the C-DRX cycle of the non-integer unit is supported. The first message may be RRC UECapabilityInformation 311.

The base station 320 may transmit a second message including C-DRX configuration to the terminal 310 based on the RRC UECapabilityInformation 311 indicating whether the terminal 310 supports the C-DRX cycle in the non-integer unit. The second message may be an RRCReconfiguration message 321. The base station 320 may configure the C-DRX cycle in the non-integer unit by implicitly or explicitly using at least one of the following pieces of information (operation 330):
Information 1: C-DRX in the unit of ms or slot;
Information 2: Non-integer period to be applied to drx-LongCycle. This information 2 may include at least one of the following information:
Numerator and denominator in the integer format to be applied to the drx-LongCycle,
Hz in the integer format to be applied to the drx-LongCycle,
Numerator and denominator in the enum format to be applied to drx-LongCycle, or
Hz in the enum format to be applied to drx-LongCycle or a fraction obtained by converting a value of Hz,
Information 3: drx-StartOffset in the integer format; or
Information 4: Subcarrier spacing (SCS) used for slot unit calculation. The slot length, SCS, or numerology may be configured in the enum format. If this information 4 is not included, the lowest SCS among active BWPs of the DRX group may be used as the SCS used for slot unit calculation.

Based on reception of the above RRC Reconfiguration message 321, the terminal 310 may perform the following operations.

The terminal 310 may configure drx-LongCycle as a numerator and denominator, a fraction, or a value in the Hz unit (operation 331).

The terminal 310 may configure drx-StartOffset in the integer format (operation 332).

Further, the terminal 310 may configure a non-integer drx-ShortCycle with the same configuration as that of Information 2.

The terminal 310 may start a drx-onDurationTimer after drx-SlotOffset from the start of the subframe or slot when the following conditions are satisfied.

When using C-DRX in the unit of ms: Long DRX cycle is used for the DRX group, and drx-StartOffset≤[(SFN×10)+subframe number] modulo (drx-LongCycle)<drx-StartOffset+1.

When using C-DRX in the unit of slot: Long DRX cycle is used for the DRX group, and drx-StartOffset≤{{[numberOfSlotsPerFrame×SFN+slot number in the frame]×lengthOfSlot} modulo (drx-LongCycle)}<drx-StartOffset+lengthOfSlot. Here, lengthOfSlot has a value indicating the length of one slot in the unit of ms.

The above formula may be modified to facilitate calculations using well-known functions such as floor, ceil, round, floor modulo, etc. In addition, the terminal may use a fine-grained short cycle through the same level of change as drx-LongCycle when the drx-ShortCycle in the non-integer unit is configured.

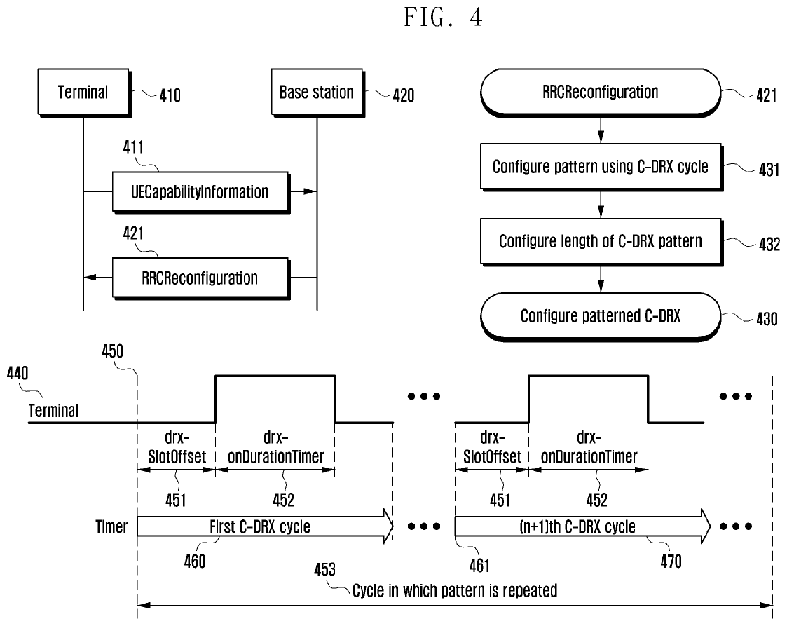

FIG. 4 illustrates a method for supporting patterned C-DRX cycles according to an embodiment of the present disclosure.

Existing C-DRX cycles and the enhanced C-DRX cycles described in this disclosure may support services including non-integer traffic periods or multiple periods through patterned C-DRX cycles.

A terminal 410 may report, to a base station 420, a first message including information indicating whether the patterned C-DRX cycle is supported. The first message may be RRC UECapabilityInformation 411.

The base station 420 may transmit, to the terminal 410, a second message including C-DRX configurations with reference to whether or not the terminal 410 supports the patterned C-DRX cycle. The second message may be an RRCReconfiguration message 421. The base station 420 may implicitly or explicitly use at least one of the following pieces of information to configure the patterned C-DRX (operation 430):
Information 1: C-DRX cycle and pattern. This information may be configured using at least one of the following methods (operation 431), and one or more of drx-onDurationTimer, drx-InactivityTimer, drx-HARQ-RTT-TimerDL, drx-HARQ-RTT-TimerUL, drx-RetransmissionTimerDL, drx-RetransmissionTimerUL, drx-ShortCycle, drx-ShortCycleTimer, drx-SlotOffset may be configured differently for each cycle:
   Repetition of C-DRX cycle configuring a pattern. As an example, a pattern of 20 ms, 20 ms, and 10 ms may be expressed,
   C-DRX cycle configuring a pattern and the number of times of repetition thereof. In an example, a pattern of 20 ms, 20 ms, and 10 ms may be expressed by two repetitions of 20 ms and one repetition of 10 ms, and/or
   C-DRX cycle configuring a pattern, implicitly or explicitly associated IDs, and sequences. For example, 20 ms is associated with ID 1, 10 ms is associated with ID 2, and 20 ms, 20 ms, 10 ms may be expressed as 1, 1, 2; and
Information 2: The sum of C-DRX cycles configuring a pattern.

The terminal may configure the sum of C-DRX cycles configuring a pattern by using information 1 or information 2, that is, a cycle in which the pattern is repeated (operation 432). Since the repetition cycle of the pattern has a fixed value, the terminal 440 may identify the repetition cycle through a condition capable of starting the drx-onDurationTimer 452 after the drx-SlotOffset 451 (indicated by reference numeral 450) from the start of the subframe or slot described in FIG. 2 or existing C-DRX techniques. However, since the C-DRX cycles configuring a pattern may not all have the same cycle, and a new method for supporting this is needed.

In case that the terminal 440 is configured with a patterned C-DRX cycle (operation 430), when a condition in which drx-onDurationTimer can be started is satisfied by replacing drx-LongCycle with a pattern repetition cycle 432 or 453 (indicated by reference numeral 450), the drx-onDurationTimer 452 may be started after the drx-SlotOffset 451 from the start of a subframe or slot according to the existing C-DRX technology or an embodiment of the disclosure, and a timer 460 having the first C-DRX cycle configuring a pattern as an expiration time may be started or restarted. When a timer having the nth cycle of the pattern as the expiration time expires (indicated by reference numeral 461), the terminal 440 may start a drx-onDurationTimer 452 after drx-SlotOffset 451 from the start of the subframe or slot according to existing C-DRX technology or an embodiment of the disclosure, and may start a timer 470 having the C-DRX cycle configuring the next pattern of the expired timer as the expiration time. A timer having a C-DRX cycle configuring the last cycle of the pattern as an expiration time may start or not.

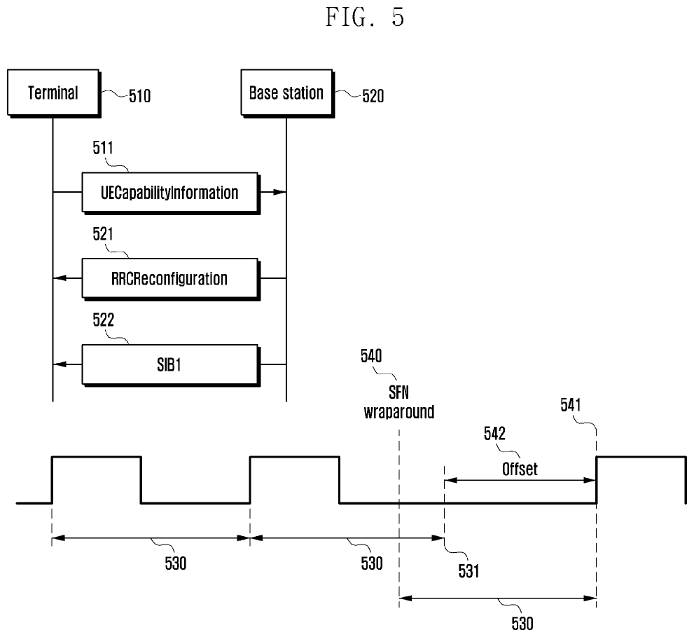

FIG. 5 illustrates a method for supporting extended-SFN wraparound according to an embodiment of the present disclosure.

An existing C-DRX technology or a C-DRX technology according to embodiments of the disclosure may determine a condition in which a drx-onDurationTimer is started based on a slot or subframe unit. The unit used for the determination, i.e., the current subframe or slot, may be expressed using the number of repeated subframes or slots starting from SFN 0. The maximum value that may be expressed is 1024 system frames, and the SFN wraps around 0 at a timepoint at which the SFN is 1024, i.e., every 10240 ms. At this timepoint, when a C-DRX cycle 530 is not a fraction of 10240, a drx-onDurationTimer may start at a different time point 541 other than an expected time point 531. This offset 542 may impact latency-critical services. To reduce the impact of the offset due to an SFN wraparound 540, the terminal may use an extended SFN for the C-DRX condition.

A terminal 510 may report, to a base station 520, a first message including information indicating whether the extended-SFN wraparound is supported. The first message may be RRC UECapabilityInformation 511.

The terminal 510 may support the extended-SFN wraparound using at least one of the following methods.
Method 1. The base station 520 may configure, for the terminal 510, the SFN to be used by the terminal 510 through a second message based on whether or not the terminal 510 supports for the extended-SFN wraparound. The second message may be an RRCReconfiguration message 521:
Method 2. The terminal 510 may, in case that the base station 520 broadcasts hyper-sfn (H-SFN) for the extended DRX by using system information block (SIB) type 1 (indicated by reference numeral 522), configure the H-SFN to be the extended-SFN used for C-DRX;
Method 3. The base station 520 may configure a value of extended-SFN to be used by the terminal 510 through the RRCReconfiguration message 521, by referring to whether or not the terminal 510 supports the extended-SFN wraparound (indicated by reference numeral 511);
Method 4. In case that the terminal 510 may determine that the enhanced C-DRX cycle using an embodiment of the disclosure or another method has been configured by the base station 520, the terminal 510 may use the extended-SFN without configuration of the base station 520; or
Method 5. The terminal 510 may be implemented without using the explicitly extended-SFN such that the offset 542 of the C-DRX cycle due to the SFN wraparound 540 does not occur.

The extended-SFN is 1024 SFNs, that is, has the unit of 10240 ms, and is incremented by one when the SFN wraparound 540 occurs. The extend-SFN may wraparound every 1024 H-SFNs, such as the H-SFN for extended DRX. Alternatively, the extended-SFN may have a value exceeding 1024.

In an embodiment, the condition of [(SFN×10)+subframe number] modulo (drx-LongCycle)=drx-StartOffset may be expressed as, when using the extended SFN, [(H-SFN×10240)+(SFN×10)+subframe number] modulo (drx-LongCycle)=drx-StartOffset (noted by H-SFN, but may be expressed using another method).

In an embodiment, the condition [numberOfSlotsPerFrame×SFN+slot number in the frame] modulo (drx-LongCycle)=drx-StartOffset may be expressed as, when using the extended-SFN, [H-SFN×numberOfSlotsPerFrame×1024+numberOfSlotsPerFrame×SFN+slot number in the frame] modulo (drx-LongCycle)=drx-StartOffset.

The extended-SFN may be easily modified and used for other technologies in which SFN wraparound may occur.

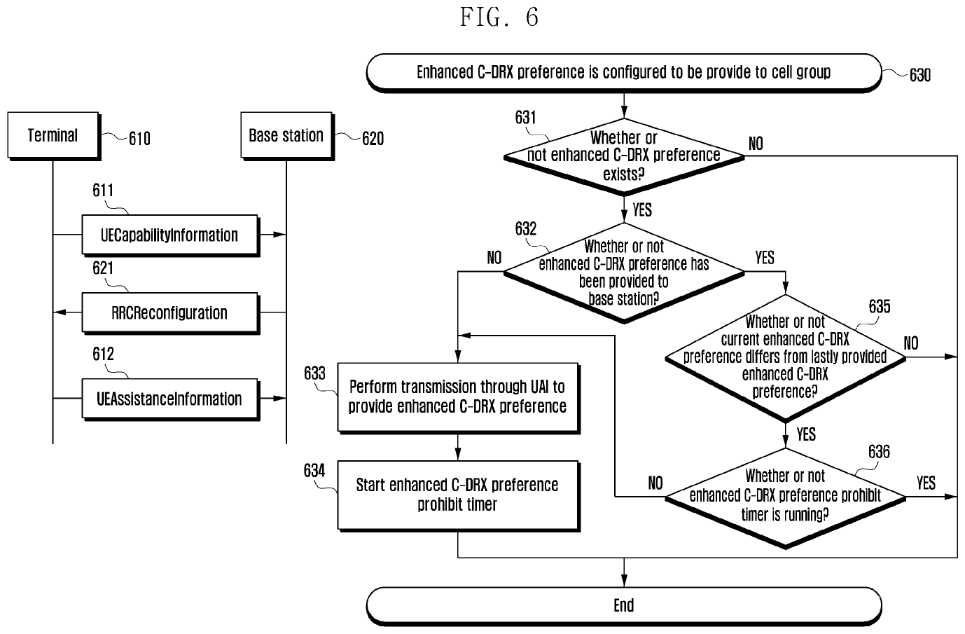

FIG. 6 illustrates a method for providing an enhanced drx preference through UAI to a base station according to an embodiment of the present disclosure.

A terminal 610 may provide the enhanced drx preference to a base station 620 to assist the base station in selecting C-DRX parameters.

The terminal 610 may report, to the base station 620, a first message indicating whether or not providing of the enhanced drx preference through UEAssistanceInformation (UAI) is supported. The first message may be RRC UECapabilityInformation 611.

Based on the information indicating whether the terminal 610 supports providing of the enhanced drx preference through UAI, the base station 620 may transmit, to the terminal 610, a second message including at least one configuration among the following configurations for providing enhanced drx preference through the UAI. The second message may be an RRCReconfiguration message 621:
Configure or release providing of enhanced C-DRX preference;
   an enhanced C-DRX preference prohibit timer; or
   an enhanced C-DRX preference indication. In case that this indication is included, the terminal 610 may provide the enhanced C-DRX preference instead of the existing drx-preference at the time of providing the drx-preference to the base station 620 through UAI 612.

The terminal 610 has been configured to provide the enhanced C-DRX preference to a cell group through the RRCReconfiguration message 621 (operation 630), and when at any time at least one of the following conditions is satisfied, the terminal may provide the enhanced C-DRX preference to the base station 620 through the UAI 612 (operation 633), and may start an enhanced C-DRX preference prohibit timer (operation 634).

Condition 1. There is an enhanced C-DRX preference of the terminal 610 (operation 631), and there has been no provision of the enhanced C-DRX preference at all after the terminal have been configured to transmit the enhanced C-DRX preference by the base station 620 (operation 632; in case that a result of the determination in operation 632 is “no”).

Condition 2. There is an enhanced C-DRX preference of the terminal 610 (operation 631), and there has been provided the enhanced C-DRX preference at least once after the enhanced C-DRX preference is configured to be provided to the base station 620 through the RRCReconfiguration message 621 (operation 632; in case that a result of the determination in operation 632 is “Yes”). In addition, the current enhanced C-DRX preference is different from the enhanced C-DRX preference lastly transmitted through the UAI 612 (operation 635; in case that a result of the determination in operation 635 is “yes”), and the enhanced C-DRX preference prohibit timer is not running (operation 636; in case that a result of the determination in operation 636 is “no”).

When providing the enhanced C-DRX preference to the base station 620 through the UAI 612, the terminal 610 may provide at least one of the following information:
Preferred value for DRX-Inactivity Timer;
   Preferred value for DRX-LongCycle;
Preferred value for DRX-Startoffset;
   Preferred value for DRX-SlotOffset;
Preferred value for DRX-ShortCycle; or
Preferred value for DRX-ShortCycleTimer.

The terminal 610 may specify a preferred value by using the method described in FIG. 2, or the method described in FIG. 3, or other methods not described herein.

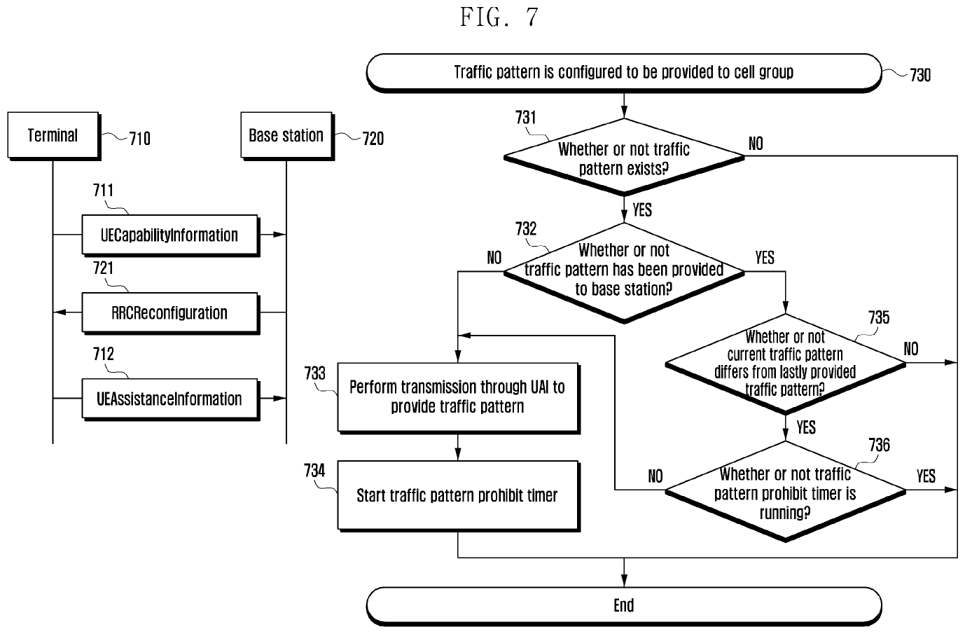

FIG. 7 illustrates a method for providing a terminal traffic pattern to a base station through UAI according to an embodiment of the present disclosure.

A terminal 710 may provide a traffic pattern to a base station to assist the base station 720 in selecting or scheduling C-DRX parameters.

The terminal 710 may report, to the base station 720, a first message including information indicating whether the terminal 710 supports providing of the traffic pattern through UEAssistanceInformation (UAI). The first message may be RRC UECapabilityInformation 711.

Based on the information indicating whether the terminal 710 supports providing of the traffic pattern through the UAI, the base station 720 may transmit, to the terminal 710, a second message including at least one of the following configurations for providing traffic patterns through the UAI. The second message may be an RRCReconfiguration message 721:
Configure or release providing of a traffic pattern; and
   A traffic pattern prohibit timer.

In case that the terminal 710 has been configured to provide a traffic pattern to a cell group through the RRCReconfiguration 721 (operation 730), and when at any time at least one of the following conditions is satisfied, the terminal 710 may provide the traffic pattern to the base station 720 through the UAI 712 (operation 733), and may start the traffic pattern prohibit timer (operation 734).

Condition 1. There is a traffic pattern of the terminal 710 (operation 731; in case that a result of the determination in operation 731 is “yes”), and there has been no provision of the traffic pattern at all after the terminal have been configured to provide the traffic pattern by the base station 720 (operation 732; in case that a result of the determination in operation 732 is “no”).

Condition 2. There is a traffic pattern of the terminal 710 (operation 731; in case that a result of the determination in operation 731 is “Yes”), and there has been provided the traffic pattern at least once after the traffic pattern is configured to be provided to the base station 720 (operation 732; in case that a result of the determination in operation 732 is “Yes”). In addition, a current traffic pattern is different from a traffic pattern lastly transmitted through the UAI 712 through the RRCReconfiguration 721 (operation 735; in case that a result of the determination in operation 735 is “yes”), and the traffic pattern preference timer is not running (operation 736; in case that a result of the determination in operation 736 is “no”).

When providing the traffic pattern to the base station 720 through the UAI 712, the terminal 710 may provide at least one of the following information:
An uplink or downlink indication;
   Traffic period. Hz, ms, us, or slot units; or
   At least one single network slice selection assistance information (S-NSSAI), a quality of service (QoS) Flow ID, a data radio bearer (DRB) ID, or a logical channel (LCH) ID, which are used for traffic transmission.

In case that multiple traffics having different periods are transmitted using the same S-NS SAI, QoS Flow ID, DRB ID, or LCH ID, the uplink or downlink indication and a traffic period may be provided in the form of a list while the traffic periods being repeated.

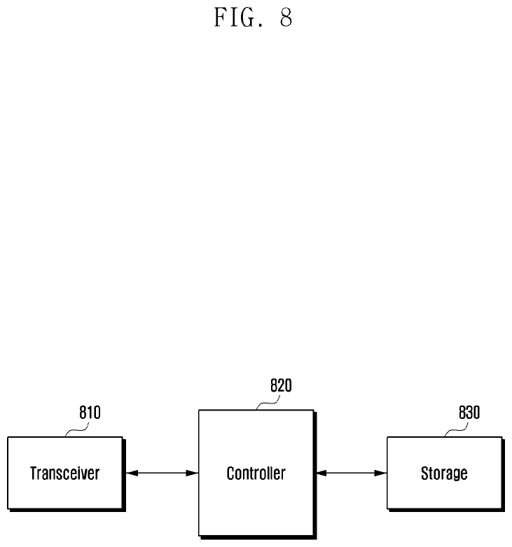

FIG. 8 illustrates a structure of a base station according to an embodiment of the present disclosure.

Referring to FIG. 8, the base station may include a transceiver 810, a controller 820, and a storage 830. The transceiver 810, the controller 820, and the storage 830 may operate according to the communication method of the base station described above. A network device may also correspond to the structure of the base station. However, the elements of the base station are not limited to the examples described above. For example, the base station may include more or fewer elements than those described above. For example, the base station may include the transceiver 810 and the controller 820. Furthermore, the transceiver 810, controller 820, and storage 830 may be implemented in the form of a single chip.

According to an embodiment, the transceiver 810, collectively referred to as including a receiver of the base station and a transmitter of the base station, may transmit or receive signals to and from a terminal, another base station, or other network entities. The transmitted received signals may include control information and data. The transceiver 810 may transmit system information to a terminal, for example, and may transmit a synchronization signal or a reference signal. To this end, the transceiver 810 may include an RF transmitter configured to up-convert and amplify the frequency of the transmitted signal, and an RF receiver configured to low-noise amplify and down-convert the frequency of the received signal. However, this is only an embodiment of the transceiver 810, and the elements of the transceiver 810 are not limited to the RF transmitter and RF receiver. Further, the transceiver 810 may include a wired or wireless transceiver, and may include various configurations for transmitting and receiving signals. In addition, the transceiver 810 may receive signals through a communication channel (e.g., a wireless channel) and output the signals to the controller 820, and transmit the signals output from the controller 820 through the communication channel. In addition, the transceiver 810 may receive communication signals and output the communication signals to a processor, and transmit the signals output from the processor to a terminal, another base station, or another network entity via a wired or wireless network.

According to an embodiment, the storage 830 may store programs and data required for operation of the base station. In addition, the storage 830 may store control information or data included in signals acquired by the base station. The storage 830 may include a storage medium, such as a ROM, RAM, hard disk, CD-ROM, and DVD, or a combination of storage media. In addition, the storage 830 may store at least one of information transmitted and received through the transceiver 810 and information generated through the controller 820.

According to an embodiment, the controller 820 may be defined in this disclosure as a circuit, an application specific integrated circuit, or at least one processor. The processor may include a communication processor (CP) configured to perform control for communication and an application processor (AP) configured to control higher layers such as applications. The controller 820 may control the overall operation of the base station according to the embodiments provided in this disclosure. For example, the controller 820 may control the signal flow between blocks to perform operations according to the flow diagram described above.

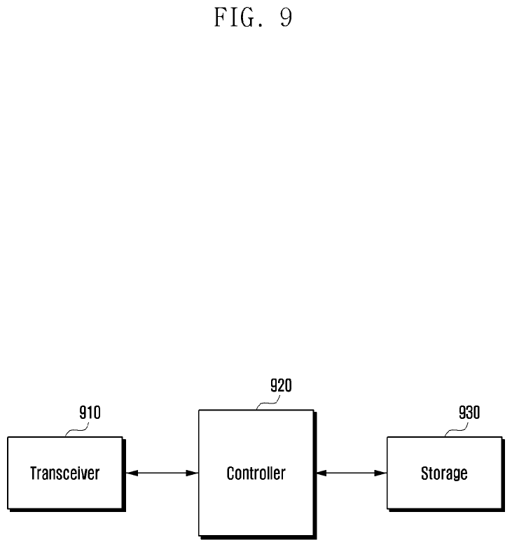

FIG. 9 illustrates the structure of a terminal according to an embodiment of the present disclosure.

Referring to FIG. 9, the terminal may include a transceiver 910, a controller 920, and a storage 930. The transceiver 910, the controller 920, and the storage 930 (or memory) may operate according to the communication method of the terminal described above. However, the elements of the terminal are not limited to the examples described above. For example, the terminal may include more or fewer elements than those described above. For example, the terminal may include the transceiver 910 and the controller 920. Furthermore, the transceiver 910, controller 920, and storage 930 may be implemented in the form of a single chip.

According to an embodiment, the transceiver 910, collectively referred to as including a receiver of the terminal and a transmitter of the terminal, may transmit or receive signals to and from a base station, another terminal, or a network entity. Signals transmitted to or received from a base station may include control information and data. The transceiver 910 may receive system information from a base station, for example, and may receive a synchronization signal or a reference signal. To this end, the transceiver 910 may include an RF transmitter configured to up-convert and amplify the frequency of the transmitted signal, and an RF receiver configured to low-noise amplify and down-convert the frequency of the received signal. However, this is only an embodiment of the transceiver 910, and the elements of the transceiver 910 are not limited to the RF transmitter and RF receiver. Further, the transceiver 910 may include a wired or wireless transceiver, and may include various configurations for transmitting and receiving signals. In addition, the transceiver 910 may receive signals through a communication channel (e.g., a wireless channel) and output the signals to the controller 920, and transmit the signals output from the controller 920 through the communication channel. In addition, the transceiver 910 may receive communication signals and output the communication signals to a processor, and transmit the signals output from the processor to a network entity via a wired or wireless network.

According to an embodiment, the storage 930 may store programs and data required for operation of the terminal. In addition, the storage 930 may store control information or data included in signals acquired by the terminal. The storage 930 may include a storage medium, such as a ROM, RAM, hard disk, CD-ROM, and DVD, or a combination of storage media.

According to an embodiment, the controller 920 may be defined in this disclosure as a circuit, an application-specific integrated circuit, or at least one processor. The processor may include a communication processor (CP) configured to perform control for communication and an application processor (AP) configured to control higher layers such as applications. The controller 920 may control the overall operation of the terminal according to the embodiments provided in this disclosure. For example, the controller 920 may control the signal flow between blocks to perform operations according to the flow diagram described above.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
transmitting, to a base station, a first message including first information indicating whether a connected mode-discontinuous reception (C-DRX) cycle of a non-integer format is supported;
receiving, from the base station, a second message including C-DRX configuration including information on the C-DRX cycle based on the first information; and
configuring the C-DRX cycle based on the information on the C-DRX cycle.

2. The method of claim 1, wherein the information on the C-DRX cycle includes at least one of information on a numerator and denominator in an integer format, hertz (Hz) information in the integer format, information on a numerator and denominator in an enumerate format, or hertz information in the enumerate format.

3. The method of claim 1, wherein the first message includes second information indicating whether system frame number (SFN) wraparound is supported, and
wherein the second message includes new SFN information based on the second information.

4. The method of claim 1, wherein the second message includes at least one of third information indicating to report enhanced DRX preference based on UE assistance information (UAI) or fourth information indicating to report a traffic pattern based on the UE assistance information,
wherein the UAI including enhanced C-DRX preference information based on the third information is transmitted to the base station, the C-DRX preference information including at least one of a preferred value of a DRX inactivation timer, a preferred value of a DRX long cycle, a preferred value of a DRX start offset, a preferred value of a DRX slot offset, a preferred value of a DRX short cycle, or a preferred value of a DRX short cycle timer, and
wherein the UAI including an uplink-downlink indication, a traffic period, or at least one of single network slice selection assistance information (S-NSSAI), a quality of service (QoS) flow identity, a data radio bearer (DRB) identity, or a logical channel (LCH) identity is transmitted to the base station.

5. The method of claim 1, wherein:
the first message includes UE capability information;
the second message includes a radio resource control (RRC) reconfiguration message; and
the C-DRX configuration includes at least one of DRX cycle information in a non-integer format related to a long DRX configuration or DRX cycle information in the non-integer format related to a short DRX configuration.

6. A method performed by a base station in a wireless communication system, the method comprising:
receiving, from a terminal, a first message including first information indicating whether a connected mode-discontinuous reception (C-DRX) cycle of a non-integer format is supported;
transmitting, to the terminal, a second message including C-DRX configuration including information on the C-DRX cycle based on the first information; and
configuring the C-DRX cycle for the terminal based on the information on the C-DRX cycle.

7. The method of claim 6, wherein the information on the C-DRX cycle includes at least one of information on a numerator and denominator in an integer format, hertz (Hz) information in the integer format, information on a numerator and denominator in an enumerate format, or hertz information in the enumerate format.

8. The method of claim 6, wherein the first message includes second information indicating whether system frame number (SFN) wraparound is supported, and
wherein the second message includes new SFN information based on the second information.

9. The method of claim 6, wherein the second message includes at least one of third information indicating to report enhanced DRX preference based on UE assistance information (UAI) or fourth information indicating to report a traffic pattern based on the UE assistance information,
wherein the UAI including enhanced C-DRX preference information based on the third information is received from the terminal, the C-DRX preference information including at least one of a preferred value of a DRX inactivation timer, a preferred value of a DRX long cycle, a preferred value of a DRX start offset, a preferred value of a DRX slot offset, a preferred value of a DRX short cycle, or a preferred value of a DRX short cycle timer, and
wherein the UAI including an uplink-downlink indication, a traffic period, or at least one of single network slice selection assistance information (S-NSSAI), a quality of service (QoS) flow identity, a data radio bearer (DRB) identity, or a logical channel (LCH) identity is received from the terminal.

10. The method of claim 6, wherein:
the first message includes UE capability information;
the second message includes a radio resource control (RRC) reconfiguration message; and
the C-DRX configuration includes at least one of DRX cycle information in a non-integer format related to a long DRX configuration or DRX cycle information in the non-integer format related to a short DRX configuration.

11. A terminal in a wireless communication system, the terminal comprising:
a transceiver; and
a controller operably coupled to the transceiver, the controller configured to:
transmit, to a base station via the transceiver, a first message including first information indicating whether a connected mode-discontinuous reception (C-DRX) cycle of a non-integer format is supported,
receive, from the base station via the transceiver, a second message including C-DRX configuration including information on the C-DRX cycle based on the first information, and
configure the C-DRX cycle based on the information on the C-DRX cycle.

12. The terminal of claim 11, wherein the information on the C-DRX cycle includes at least one of information on numerator and denominator in an integer format, hertz (Hz) information in the integer format, information on a numerator and denominator in an enumerate format, or hertz information in the enumerate format.

13. The terminal of claim 11, wherein the first message includes second information indicating whether system frame number (SFN) wraparound is supported, and
wherein the second message includes new SFN information based on the second information.

14. The terminal of claim 11, wherein the second message includes at least one of third information indicating to report enhanced DRX preference based on UE assistance information (UAI) or fourth information indicating to report a traffic pattern based on the UE assistance information,
wherein the UAI including enhanced C-DRX preference information based on the third information is transmitted to the base station, the C-DRX preference information including at least one of a preferred value of a DRX inactivation timer, a preferred value of a DRX long cycle, a preferred value of a DRX start offset, a preferred value of a DRX slot offset, a preferred value of a DRX short cycle, or a preferred value of a DRX short cycle timer, and
wherein the UAI including an uplink-downlink indication, a traffic period, or at least one of single network slice selection assistance information (S-NSSAI), a quality of service (QoS) flow identity, a data radio bearer (DRB) identity, or a logical channel (LCH) identity is transmitted to the base station.

15. The terminal of claim 11, wherein:
the first message includes UE capability information;
the second message includes a radio resource control (RRC) reconfiguration message; and
the C-DRX configuration includes at least one of DRX cycle information in a non-integer format related to a long DRX configuration or DRX cycle information in the non-integer format related to a short DRX configuration.

16. A base station in a wireless communication system, the base station comprising:
a transceiver; and
a controller operably coupled to the transceiver, the controller configured to:
receive, from a terminal via the transceiver, a first message including first information indicating whether a connected mode-discontinuous reception (C-DRX) cycle of a non-integer format is supported,
transmit, to the terminal via the transceiver, a second message including C-DRX configuration including information on the C-DRX cycle based on the first information, and
configure the C-DRX cycle for the terminal based on the information on the C-DRX cycle.

17. The base station of claim 16, wherein the information on the C-DRX cycle includes at least one of information on a numerator and denominator in an integer format, hertz (Hz) information in the integer format, information on a numerator and denominator in an enumerate format, or hertz information in the enumerate format.

18. The base station of claim 16, wherein the first message includes second information indicating whether system frame number (SFN) wraparound is supported, and
wherein the second message includes new SFN information based on the second information.

19. The base station of claim 16, wherein the second message includes at least one of third information indicating to report enhanced DRX preference based on UE assistance information (UAI) or fourth information indicating to report a traffic pattern based on the UE assistance information,
wherein the UAI including enhanced C-DRX preference information based on the third information is received from the terminal, the C-DRX preference information including at least one of a preferred value of a DRX inactivation timer, a preferred value of a DRX long cycle, a preferred value of a DRX start offset, a preferred value of a DRX slot offset, a preferred value of a DRX short cycle, or a preferred value of a DRX short cycle timer, and
wherein the UAI including an uplink-downlink indication, a traffic period, or at least one of single network slice selection assistance information (S-NSSAI), a quality of service (QoS) flow identity, a data radio bearer (DRB) identity, or a logical channel (LCH) identity is received from the terminal.

20. The base station of claim 16, wherein:
the first message includes UE capability information;
the second message includes a radio resource control (RRC) reconfiguration message; and
the C-DRX configuration includes at least one of DRX cycle information in a non-integer format related to a long DRX configuration or DRX cycle information in the non-integer format related to a short DRX configuration.
